(19) United States
(12) Patent Application Publication
(10) Pub. No.: US 2013/0037032 A1
(43) Pub. Date: Feb. 14, 2013

(54) MASK

(71) Applicants: Akira Shibata, Kagawa (JP); Eisuke Takeda, Kagawa (JP)

(72) Inventors: Akira Shibata, Kagawa (JP); Eisuke Takeda, Kagawa (JP)

(21) Appl. No.: 13/579,514

(22) PCT Filed: Feb. 18, 2011
(86) PCT No.: PCT/JP2011/053572

§ 371 Date: Oct. 18, 2012

(30) Foreign Application Priority Data
Feb. 19, 2010 (JP) 2010-035448

(51) Int. Cl. A62B 18/02

(52) U.S. Cl. 128/206.19

(57) ABSTRACT

A mask that can prevent spaces from forming between a mask body and a wearer's face. In the mask, the top base and bottom base of a left ear loop are joined to the mask body at a top joining part and bottom joining part, respectively. Also, the top base and bottom base of a right ear loop are joined to the mask body at a top joining part and bottom joining part, respectively. In the top joining parts, joining part bottoms, which are at the bottom in a second direction, are shifted away from rims in a first direction with respect to joining part tops, which are at the top in the second direction.

### BACKGROUND OF THE INVENTION

1. Field of the Invention

The present invention relates to a technique of constructing a mask which covers a mouth and a nose of a wearer.

2. Description of the Related Art

A mask which covers wearer's mouth and nose is disclosed, for example, in Japanese laid-open Utility Model Publication No. 51-15893. This known mask has a mask body which covers a wearer's mouth and left and right ear straps. The mask body has a plurality of parallel pleats and forms a three-dimensional shape when the mask is worn. Further, a narrow rubber band or the like is used as the left and right ear straps.
Prior art reference: Japanese laid-open Utility Model Publication No. 51-15893

### SUMMARY OF THE INVENTION

In the known mask, a narrow rubber band is used as the left and right ear straps, so that space is easily formed between the mask body and the wearer's face. Therefore, in order to prevent space from being formed, for example, as shown in FIG. 15(a), a band-like left ear strap 330 may be bonded to a mask body 320. The left ear strap 330 has an upper base 331a and a lower base 331c which are located away from each other in a direction 80 (vertical direction) transverse to a direction 70 (horizontal direction) in which the left ear strap 330 and a right ear strap (not shown) are disposed. Further, the left ear strap 330 extends from the upper base 331a and the lower base 331c, and has a band-like rim (ear strap part) 335 which defines an opening 330a. The upper base 331a and the lower base 331c are bonded to the mask body 320 by an upper bonding part 323 and a lower bonding part 324 which extend along a straight line running along the vertical direction 80. When such a mask 310 is worn, as shown in FIG. 15(b), the mask body 320 and the left ear strap 330 are deformed. For example, a region of the left ear strap 330 which is connected to the upper base 331a is stretched. At this time, the upper bonding part 323 is bent with respect to the mask body 320, so that a difference is caused in the degree of stretching. For example, in the region of the left ear strap 330 which is connected to the upper base 331a, a lower edge 336d is stretched from 60 mm to 100 mm in the horizontal length (degree of stretching=170%), while the lower edge 336u is stretched only from 60 mm to 90 mm (degree of stretching=150%). Therefore, when the mask is worn, regions (shown surrounded by broken lines in FIG. 15(b)) having a lower degree of stretching do not fit on the wearer's face so that space is formed between the mask body 320 and the wearer's face. Particularly, in the ear strap region connected to the upper base 331a, the difference in the degree of stretching is easily caused.

Accordingly, it is an object of the present invention to provide an effective technique for preventing space from being formed between the mask body and the wearer's face when the mask is worn.

A mask according to the present invention may be of disposable type designed for single use, disposable type designed for multiple use which can be used several times or reusable type which can be reused by washing.

In the present invention, the mask has at least a mask body and first and second ear straps. The mask body is designed to cover a mouth and a nose of a wearer, and the first and second ear straps are designed to be hooked around wearer's left and right ears. The first and second ear straps are bonded to the mask body by a first bonding part and a second bonding part, respectively, which are located away from each other in a first direction.

Further, the first ear strap and the second ear strap are hooked around the wearer's left ear and the wearer's right ear, respectively. The “first direction” represents a longitudinal direction (width direction) of the mask body and corresponds to a horizontal direction when viewed from a wearer wearing the mask. One direction to “one side in the first direction” represents a direction from the first ear strap toward the second ear strap and corresponds to a direction from left to right when viewed from the wearer wearing the mask. The other direction to “the other side in the first direction” represents a direction from the second ear strap toward the first ear strap and corresponds to a direction from right to left when viewed from the wearer wearing the mask.

The mask body has a plurality of pleats which extend parallel in the first direction. Typically, the mask body is configured as a pleated mask body which forms a three-dimensional shape when the mask is worn.

The mask body and the first and second ear straps are typically formed by bonding one or more sheet pieces. The sheet piece is formed by fixing or intertwining fibers, for example, by mechanical, chemical or heat treatment. Typically, the sheet piece comprises a nonwoven fabric sheet which partly includes heat fusible synthetic fibers (thermoplastic synthetic fibers) and can be fusion bonded. The first and second ear straps are suitably formed of a stretch nonwoven fabric sheet piece.

In order to bond the first and second ear straps to the mask body, various bonding methods such as fusion bonding and adhesive bonding can be used. The first and second bonding parts consist of bonding portions which have various shapes such as a linear shape (a straight line or a curved line) and a point-like shape and are formed along a line (a straight line or a curved line) or discontinuously.

The first ear strap has a first lower base and a first upper base which are located away from each other in a second direction transverse to the first direction. The first lower base is disposed to one side in the second direction with respect to the first upper base. Further, the first ear strap has a first rim which extends from the first lower base and the first upper base and defines an opening. The first lower base and the first upper base are bonded to the mask body by a first lower bonding part and a first upper bonding part of the first bonding part, respectively. The second ear strap has a second lower base and a second upper base which are located away from each other in the second direction. The second lower base is disposed to one side in the second direction with respect to the second upper base. Further, the second ear strap has a second rim which extends from the second lower base and the second upper base and defines an opening. The second lower base and the second upper base are bonded to the mask body by a second lower bonding part and a second upper bonding part of the second bonding part, respectively.

The first rim is a part to be hooked around the wearer's left ear and the second rim is a part to be hooked around the wearer's right ear. The first ear strap and the second ear strap are disposed on a wearing face (wearer side) or a non-wearing face. The first lower base, the first upper base, the second lower base and the second upper base are bonded to the mask body at least in part. The “second direction transverse to the first direction” represents a direction (height direction) transverse to the longitudinal direction of the mask body and corresponds to a vertical direction with respect to the wearer wearing the mask. One direction to “one side in the second direction” represents a direction from the upper edge toward the lower edge of the mask body and corresponds to a direction from top to bottom of the wearer wearing the mask. The other direction to “the other side in the second direction” represents a direction from the lower edge toward the upper edge of the mask body and corresponds to a direction from down to top of the wearer wearing the mask.

The first upper bonding part is provided such that an end portion of the first upper bonding part on the one side in the second direction is disposed to the one side in the first direction with respect to an end portion of the first upper bonding part on the other side in the second direction. Further, the second upper bonding part is provided such that an end portion of the second upper bonding part on the one side in the second direction is disposed to the other side in the first direction with respect to an end portion of the second upper bonding part on the other side in the second direction. Specifically, the first upper bonding part (the second upper bonding part) is formed such that the one end portion in the second direction is disposed to the opposite side of the other end portion in the second direction from the first rim (the second rim) in the first direction.

In the present invention, in a region of the first ear strap connected to the first upper base and a region of the second ear strap connected to the second upper base, a difference between the both edges of each strap in the second direction in the degree of stretching when the mask is worn can be reduced. Thus, the difference in the degree of stretching in these regions when the mask is worn can be made equal, so that space can be prevented from being formed in the regions of the first and second upper bonding parts.

In a different embodiment according to the present invention, the first lower bonding part is provided such that an end portion of the first lower bonding part on the other side in the second direction is disposed to the one side in the first direction with respect to an end portion of the first lower bonding part on the one side in the second direction. Further, the second lower bonding part is provided such that an end portion of the second lower bonding part on the other side in the second direction is disposed to the other side in the first direction with respect to an end portion of the second lower bonding part on the one side in the second direction. Specifically, the first lower bonding part (the second lower bonding part) is formed such that the other end portion in the second direction is disposed to the opposite side of the one end portion in the second direction from the first rim (the second rim) in the first direction.

In this embodiment, when the mask is worn, in a region of the first ear strap connected to the first lower base and a region of the second ear strap connected to the second lower base, a difference between the both edges of each strap in the second direction in the degree of stretching when the mask is worn can be reduced. Thus, the difference in the degree of stretching in these regions when the mask is worn can be made equal, so that space can be prevented from being formed in the regions of the first and second lower bonding parts.

### EFFECT OF THE INVENTION

In the mask according to the present invention, when the mask is worn, space can be prevented from being formed between the mask body and the wearer's face. Other objects, features and advantages of the present invention will be readily understood after reading the following detailed description together with the accompanying drawings and the claims.

### BRIEF DESCRIPTION OF THE DRAWINGS

FIG. 1 shows a mask according to an embodiment as viewed from a non-wearing face side when the mask is not worn.

FIG. 2 shows the mask according to the embodiment as viewed from a wearing face side when the mask is not worn.

FIG. 3 shows a mask body when the mask is not worn.

FIG. 4 shows the mask body when the mask is worn.

FIG. 5 illustrates stretching of the mask of the embodiment when it is worn.

FIG. 6 shows a different embodiment of a bonding part.

FIG. 7 shows a different embodiment of the bonding part.

FIG. 8 shows a different embodiment of the bonding part.

FIG. 9 shows a different embodiment of the bonding part.

FIG. 10 shows a different embodiment of the bonding part.

FIG. 11 shows a different embodiment of the bonding part.

FIG. 12 shows a mask according to another embodiment.

FIG. 13 shows a mask according to a further embodiment as viewed from the wearing face side when the mask is not worn.

FIG. 14 shows the mask according to the further embodiment as viewed from a wearing face side when the mask is worn.

FIG. 15 illustrates stretching of a known mask when it is worn.

### DETAILED DESCRIPTION OF THE INVENTION

Each of the additional features and method steps disclosed above and below may be utilized separately or in conjunction with other features and method steps to provide and manufacture improved masks and method for using such masks and devices utilized therein.

Representative examples of the present invention, which examples utilized many of these additional features and method steps in conjunction, will now be described in detail with reference to the drawings. This detailed description is merely intended to teach a person skilled in the art further details for practicing preferred aspects of the present teachings and is not intended to limit the scope of the invention.

Only the claims define the scope of the claimed invention. Therefore, combinations of features and steps disclosed within the following detailed description may not be necessary to practice the invention in the broadest sense, and are instead taught merely to particularly describe some representative examples of the invention, which detailed description will now be given with reference to the accompanying drawings. An embodiment according to the present invention is now explained with reference to the drawings.

In this specification, “directions” are defined as follows.

A “first direction 70” represents a longitudinal direction (width direction) of a mask body 20 and corresponds to a horizontal direction when viewed from a wearer wearing the mask (which is referred to as the “horizontal direction”). One direction to “one side in the first direction 70” represents a direction from a left ear strap (a first ear strap) 30 toward a right ear strap (a second ear strap) 40 and corresponds to a direction from left to right when viewed from the wearer wearing the mask (which is referred to as the “right”). The other direction to “the other side in the first direction 70” represents a direction from the right ear strap (the second ear strap) 40 toward the left ear strap (the first ear strap) 30 and corresponds to a direction from right to left when viewed from the wearer wearing the mask (which is referred to as the “left”). Further, the “right” and the “left” here refer to the directions when viewed from the wearer wearing the mask. Therefore, when the “right” and the “left” are used herein for the mask as viewed from its non-wearing side, the “right” and the “left” are opposite to the actual “right” and “left”.

Further, a “second direction 80” represents a direction (height direction) transverse to the longitudinal direction of the mask body 20 and corresponds to a vertical direction with respect to the wearer wearing the mask (which is referred to as the “vertical direction”). One direction to “one side in the second direction 80” represents a direction from an upper end toward a lower end of the mask body 20 and corresponds to a direction from top to bottom of the wearer wearing the mask (which is referred to as the “downward direction”). The other direction to “the other side in the second direction 80” represents a direction from the lower end toward the upper end of the mask body 20 and corresponds to a direction from down to top of the wearer wearing the mask (which is referred to as the “upward direction”).

Further, a “third direction 90” represents a front-back direction of the mask body 20 and corresponds to a front-back direction of the wearer wearing the mask (which is referred to as the “front-back direction”). One direction to “one side in the third direction 90” represents a direction from a non-wearing face 20Y toward a wearing face 20X of the mask body 20 and corresponds to a direction from front to back of the wearer wearing the mask (which is referred to as the “backward direction”). The other direction to “the other side in the third direction 90” represents a direction from the wearing face 20X toward the non-wearing face 20Y and corresponds to a direction away from the wearer wearing the mask (which is referred to as the “frontward direction”).

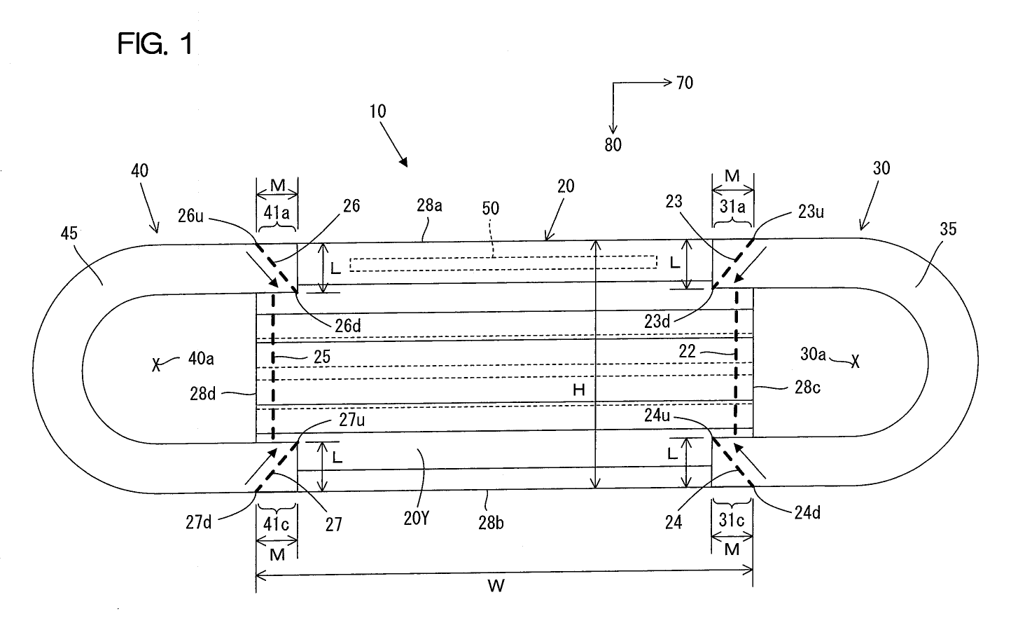

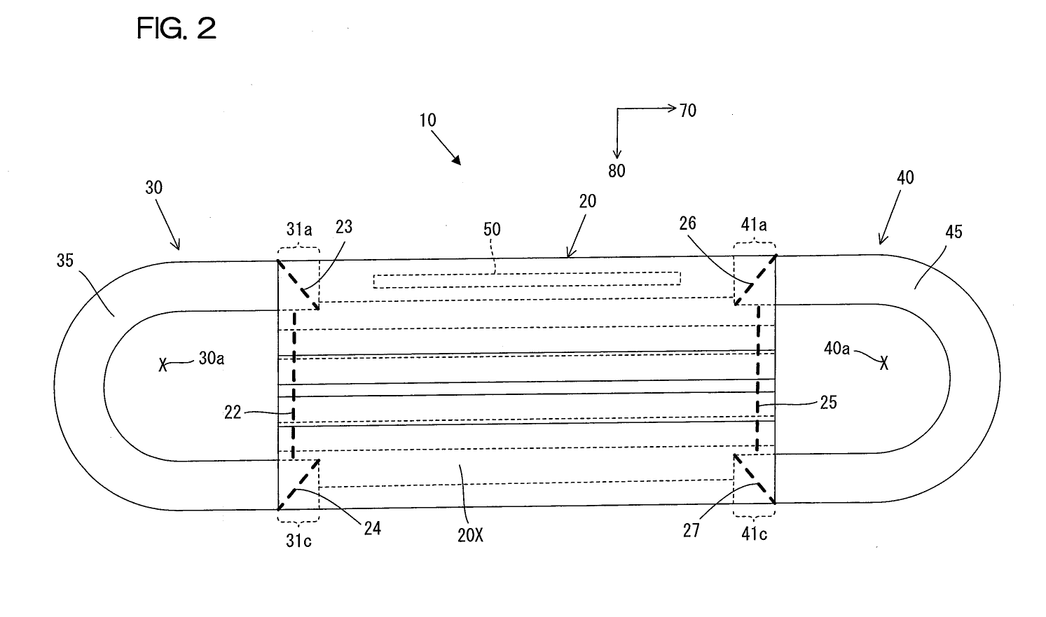

A mask 10 according to an embodiment of the present invention is now explained with reference to FIGS. 1 and 2. The mask 10 of this embodiment is designed as a disposable mask for single or multiple use which can be used once or several times. Further, the mask 10 can be used for various purposes including protection against pollens, protection against viruses such as cold viruses, and environmental improvement such as moisture retention around the mouth and in the nose.

FIG. 1 shows the mask 10 of this embodiment as viewed from the non-wearing face 20Y side (opposite to the wearing face 20X side) when the mask is not worn, and FIG. 2 shows the mask 10 of this embodiment as viewed from the wearing face 20X side when the mask is not worn.

As shown in FIGS. 1 and 2, the mask 10 of this embodiment includes a mask body 20, a left ear strap 30 and a right ear strap 40. The mask body 20 is designed to cover the mouth and nose of a wearer. The left ear strap 30 and the right ear strap 40 are designed to be hooked around the left and right ears of the wearer, respectively. The mask body 20, the left ear strap 30 and the right ear strap 40 are features that correspond to the “mask body”, the “first ear strap” and the “second ear strap”, respectively, according to this invention.

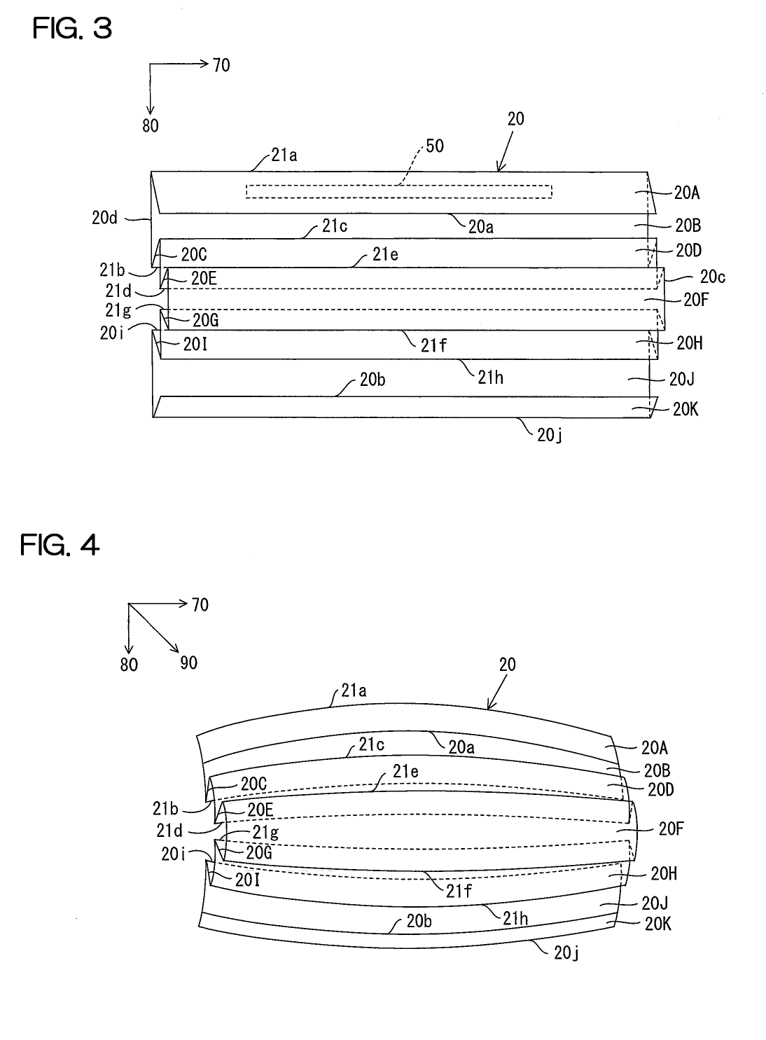

The mask body 20 has a plurality of pleats extending along the first direction 70 (the horizontal direction) and is configured as a pleated mask body. In this embodiment, as shown in FIG. 3, a rectangular sheet piece having an upper side 20a, a lower side 20b, a left side 20c and a right side 20d is folded in order along a plurality of folding lines 21a to 21j which extend in parallel to the upper side 20a and the lower side 20b (in parallel to the first direction 70). Thus, a plurality of pleats 20B to 20J extending along the first direction 70 are arranged along the second direction 80 (the vertical direction) transverse to the first direction 70. When the mask is not worn, the mask body 20 has a rectangular shape (having an upper side 28a, a lower side 28b, a left side 28c and a right side 28d) having a width W in the first direction 70 and a height H in the second direction 80. Naturally, the shape of the mask body 20 is not limited to the rectangular shape.

Further, a shape retaining part 50 is held by a folded piece 20A folded back along the folding line 21a and the pleat 20B. When the mask is worn, the shape retaining part 50 serves to fit an upper end portion of the mask body 20 to contours of the wearer's face in order to reduce space between the mask body 20 and the wearer's face. The shape retaining part 50 is preferably provided such that it can be easily bent and has a sufficient rigidity for retaining the bent shape. For example, the shape retaining part 50 is formed by a thin plate made of synthetic resin or metal. The shape retaining part 50 is held on the mask body 20 by a variety of methods.

The pleats 20B to 20J are bonded together at opposite ends in the first direction 70 by appropriate methods.

The mask body 20 is preferably formed by nonwoven fabric sheets which are formed of thermoplastic fibers and stacked in three layers of an outer layer on the side facing away from the wearer, a filter layer (intermediate layer), and an inner layer on the side facing the wearer. The nonwoven fabric sheet may be manufactured, for example, by through-air bonding, spun bonding, thermal bonding, spun lacing, point bonding, melt blowing, stitch bonding, chemical bonding, needle punching or other similar methods by using fibers such as polyethylene, polypropylene or polyethylene terephthalate. Further, the nonwoven fabric sheet having a basis weight of 10 to 150 g/m² is used. Preferably, the nonwoven fabric sheet forming the outer layer and the inner layer has high air-permeability and is nice and soft to wear, and the nonwoven fabric sheet forming the filter layer has high air-permeability and high barrier properties (trapping efficiency).

In this embodiment, each of the left ear strap 30 and the right ear strap 40 is bonded to the mask body 20 on the non-wearing face 20Y of the mask body 20.

In this embodiment, the mask body 20 and the left and right ear straps 30, 40 are separately formed. The mask body 20 however may also be integrally formed together with the left and right ear straps 30, 40. For example, the mask body can be formed having the left and right ear straps 30, 40 overlaid on top of the mask body 20 by folding back one sheet piece.

Each of the left and right ear straps 30, 40 is formed of a sheet piece. Like the mask body 20, a nonwoven fabric sheet formed of thermoplastic synthetic fibers can be used as the sheet piece for forming the left and right ear straps 30, 40, and preferably, a nonwoven fabric sheet having higher stretchiness is used. For example, nonwoven fabric sheets having a basis weight of 30 to 120 g/m², such as a stretch SB nonwoven fabric sheet (spun-bonded nonwoven fabric sheet), a stretch SMS nonwoven fabric sheet (spun-bonded/melt-blown composite nonwoven fabric sheet), a (stretch SB-film-SB) nonwoven fabric sheet, a stretch spun-laced nonwoven fabric sheet or a stretch hot-melt-adhesive (HMA) nonwoven fabric sheet, are used.

The left ear strap 30 has a base and a rim (ear strap part) 35 extending from the base and defining an opening 30a. The base has an upper base 31a and a lower base 31c which are located away from each other in the second direction 80. The lower base 31c is disposed below the upper base 31a in the second direction 80. The rim 35 extends from the upper and lower bases 31a, 31c and is designed to be hooked around the wearer's right ear through the opening 30a. The upper base 31a, the lower base 31c and the rim 35 are features that correspond to the “first upper base”, the “first lower base” and the “first rim”, respectively, according to the present invention.

The left ear strap 30 is disposed on the other (left) end region of the non-wearing face 20Y of the mask body 20 in the first direction 70 such that the rim 35 is located on the other side (left) of the upper and lower bases 31a, 31c in the first direction 70.

The upper and lower bases 31a, 31c of the left ear strap 30 are bonded to the mask body 20 by an upper bonding part 23 and a lower bonding part 24. The upper and lower bonding parts 23, 24 consist of bonding portions having linear, point-like or other various shapes. The upper bonding part 23 and the lower bonding part 24 are features that correspond to the “first upper bonding part” and the “first lower bonding part”, respectively, according to the present invention.

The upper bonding part 23 has a bonding portion on its lower end in the second direction 80 (a lower bonding portion 23d), a bonding portion on its upper end in the second direction 80 (an upper bonding portion 23u) and a bonding portion between the lower bonding portion 23d and the upper bonding portion 23u. Here, the lower bonding portion 23d is formed to the one side (right) of the upper bonding portion 23u in the first direction 70. In this embodiment, the upper bonding part 23 has a bonding portion formed along a line connecting the lower bonding portion 23d and the upper bonding portion 23u. Specifically, the lower bonding portion 23d is arranged to the opposite side of the upper bonding portion 23u from the rim 35.

The lower bonding part 24 has a bonding portion on its upper end in the second direction 80 (an upper bonding portion 24u), a bonding portion on its lower end in the second direction 80 (a lower bonding portion 24d) and a bonding portion between the upper bonding portion 24u and the lower bonding portion 24d. Here, the upper bonding portion 24u is formed to the other side (left) of the lower bonding portion 24d in the first direction 70. In this embodiment, the lower bonding part 24 has a bonding portion formed along a line connecting the lower bonding portion 24d and the upper bonding portion 24u. Specifically, the upper bonding portion 24u is arranged to the opposite side of the lower bonding portion 24d from the rim 35.

The right ear strap 40 has a base and a rim (ear strap part) 45 extending from the base and defining an opening 40a. The base has an upper base 41a and a lower base 41c which are located away from each other in the second direction 80. The lower base 41c is disposed below the upper base 41a in the second direction 80. The rim 45 extends from the upper and lower bases 41a, 41c and is designed to be hooked around the wearer's left ear through the opening 40a. The upper base 41a, the lower base 41c and the rim 45 are features that correspond to the “second upper base”, the “second lower base” and the “second rim”, respectively, according to the present invention.

The right ear strap 40 is disposed on the one (right) end region of the non-wearing face 20Y of the mask body 20 in the first direction 70 such that the rim 45 is located on the one side (right) of the upper and lower bases 41a, 41c in the first direction 70.

The upper base 41a and the lower base 41c of the right ear strap 40 are bonded to the mask body 20 by an upper bonding part 26 and a lower bonding part 27. The upper and lower bonding parts 26, 27 consist of bonding portions having linear, point-like or other various shapes. The upper bonding part 26 and the lower bonding part 27 are features that correspond to the “second upper bonding part” and the “second lower bonding part”, respectively, according to the present invention.

The upper bonding part 26 has a bonding portion on its lower end in the second direction 80 (a lower bonding portion 26d), a bonding portion on its upper end in the second direction 80 (an upper bonding portion 26u) and a bonding portion between the lower bonding portion 26d and the upper bonding portion and 26u. Here, the lower bonding portion 26d is formed to the right of the upper bonding portion 26u in the first direction 70. In this embodiment, the upper bonding part 26 has a bonding portion formed along a line connecting the lower bonding portion 26d and the upper bonding portion 26u. Specifically, the lower bonding portion 26d is arranged to the opposite side of the upper bonding portion 26u from the rim 45.

The lower bonding part 27 has a bonding portion on its upper end in the second direction 80 (an upper bonding portion 27u), a bonding portion on its lower end in the second direction 80 (a lower bonding portion 27d) and a bonding portion between the upper bonding portion 27u and the lower bonding portion 27d. Here, the upper bonding portion 27u is formed to the left of the lower bonding portion 27d in the first direction 70. In this embodiment, the lower bonding part 27 has a bonding portion formed along a line connecting the lower bonding portion 27d and the upper bonding portion 27u. Specifically, the upper bonding portion 27u is arranged to the opposite side of the lower bonding portion 27d from the rim 45.

Further, the width of each of the upper base 31a (41a) and the lower base 31c (41c) of the left ear strap 30 (the right ear strap 40), or the width of each connection between the upper base 31a (41a) and lower base 31c (41c) and the rim 35 (45) is set to be L. For example, a height H of the mask body 20 is set to be 70 to 110 mm and the width L of the upper base 31a (41a) and the lower base 31c (41c) is set to be 10 to 30 mm. Specifically, in this embodiment, the rim 35 (45) of the left ear strap 30 (the right ear strap 40) is configured as a band-like member having a certain width. Further, a length M of each of the upper bonding part 23 (26) and the lower bonding part 24 (27) is set to be 2 to 20 mm.

The mask body 20 (pleats 20B to 20J) is bonded at its left end along the first direction 70 by the upper and lower bonding parts 23, 24 and by a middle bonding part 22. In this embodiment, the middle bonding part 22 is formed between the upper base 31a and the lower base 31c. The middle bonding part 22 is a feature that corresponds to the “first middle bonding part” according to this invention. Further, the upper bonding part 23, the lower bonding part 24 and the middle bonding part 22 form the “left bonding part”. The left bonding part is a feature that corresponds to the “first bonding part for bonding the first ear strap to the mask body” according to this invention. The left bonding part may also be formed by the upper bonding part 23 and the lower bonding part 24.

Further, the mask body 20 (pleats 20B to 20J) is bonded at its right end in the first direction 70 by the upper and lower bonding parts 26, 27 and by a middle bonding part 25. In this embodiment, the middle bonding part 25 is formed between the upper base 41a and the lower base 41c. The middle bonding part 25 is a feature that corresponds to the “second middle bonding part” according to this invention. Further, the upper bonding part 26, the lower bonding part 27 and the middle bonding part 25 form the “right bonding part”. The right bonding part is a feature that corresponds to the “second bonding part for bonding the second ear strap to the mask body” according to this invention. The right bonding part may also be formed by the upper bonding part 26 and the lower bonding part 27.

Further, the middle bonding part 22 is disposed to the opposite side of the upper bonding portion 23u of the upper bonding part 23 and the lower bonding portion 24d of the lower bonding part 24, from the rim 35 in the first direction 70, while the middle bonding part 25 is disposed to the opposite side of the upper bonding portion 26u of the upper bonding part 26 and the lower bonding portion 27d of the lower bonding part 27, from the rim 45 in the first direction 70.

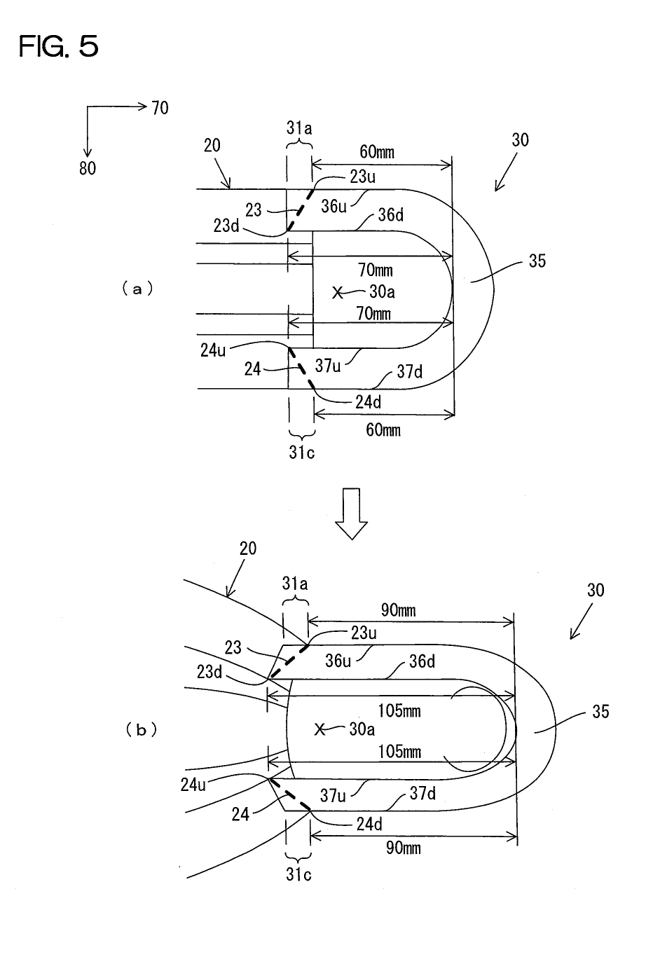

As described above, in this embodiment, the upper bonding part 23 (26) for bonding the upper base 31a (41a) to the mask body 20 is formed such that the lower bonding portion 23d (26d) on the lower end in the second direction 80 is disposed to the opposite side (right) of the upper bonding portion 23u (26u) formed on the upper end in the second direction 80, from the rim 35 in the first direction 70. Further, the lower bonding part 24 (27) for bonding the lower base 31c (41c) to the mask body 20 is formed such that the upper bonding portion 24u (27u) on the upper end in the second direction 80 is disposed to the opposite side (left) of the lower bonding portion 24d (27d) formed on the lower end in the second direction 80, from the rim 45 in the first direction 70. Thus, as shown in FIG. 5(a), in a region of the ear strap connected to the upper base 31a, a distance between the upper bonding portion 23u and a right end of the opening 30a is shorter than a distance between the lower bonding portion 23d and a right end of the opening 30a. Specifically, in FIG. 5(a), the former distance on an upper edge 36u side is 60 mm and the latter distance on a lower edge 36d side is 70 mm.

Next, an operation of putting on the mask 10 according to this embodiment is now explained. In the state shown in FIGS. 1 and 2, central regions of the pleats 20B, 20J on the both ends of the mask 10 in the second direction 80 are pulled along the second direction 80. Thus, as shown in FIG. 4, the central regions of the pleats 20B to 20J of the mask body 20 in the first direction 70 expand in the second direction 80. At this time, a distance between the central pleat 20F and the pleats 20A, 20K on the both ends of the mask body 20 is widened in a third direction 90 (front-back direction). Specifically, the mask body 20 takes a three-dimensional form.

Further, the rim 35 of the left ear strap 30 and the rim 45 of the right ear strap 40 are pulled in the first direction, and then the left ear strap 30 is hooked around the left ear through the opening 30a and the right ear strap 40 is also hooked around the wearer's right ear through the opening 40a.

At this time, as described above, the upper bonding parts 23, 26 and the lower bonding parts 24, 27 are bent with respect to the mask body 20, so that a difference in the degree of stretching is caused in the ear straps.

In this embodiment, as shown in FIG. 5(a), in each of the regions of the ear straps connected to the upper bases 31a, 41a, the above-described distance on the upper edge side is shorter than the above-described distance on the lower edge side. Further, in each of the regions of the ear straps connected to the lower bases 31a, 41a, the distance on the lower edge side is shorter than the distance on the upper edge side. Therefore, as shown in FIG. 5(b), the difference which is caused in the degree of stretching when the mask is worn is reduced. For example, in the region of the ear strap connected to the upper base 31a, the upper edge 36u is stretched from 60 mm to 90 mm in the horizontal length (degree of stretching=150%) and the lower edge 36d is stretched in the horizontal length from 70 mm to 105 mm (degree of stretching=150%).

In this manner, the difference in the degree of stretching which is caused when the mask is worn is reduced, so that space can be prevented from being formed between the mask body 20 and the wearer's face when the mask is worn.

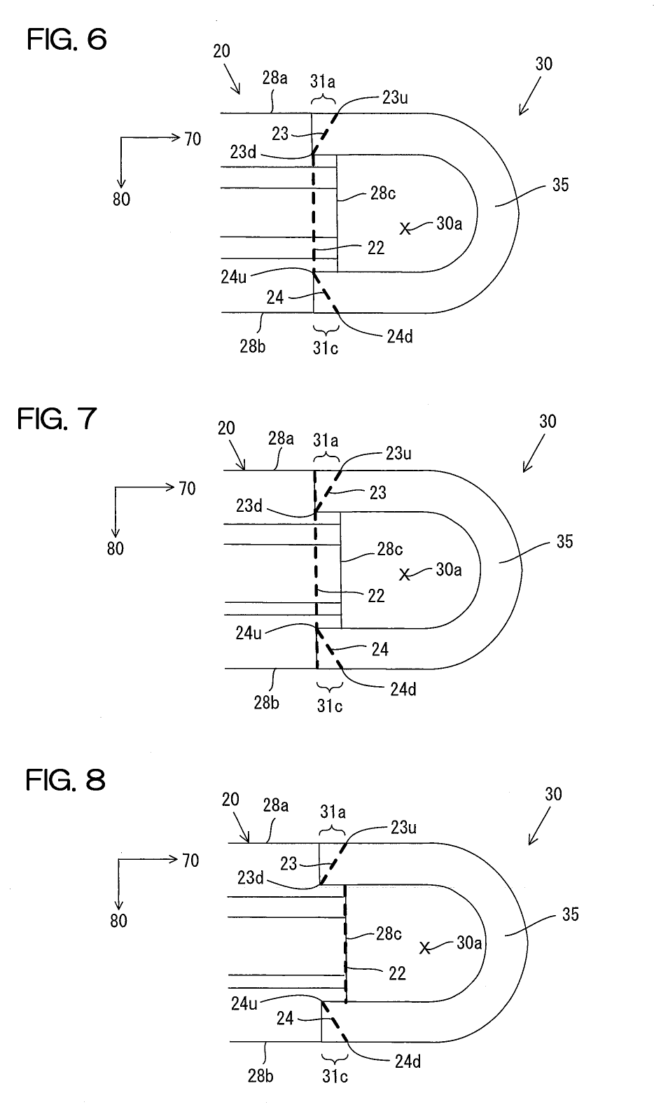

It is essential for the middle bonding part 22 for bonding the pleats forming the mask body 20 to be located so as not to exist to the rim 35 side (left in the first direction 70) of the upper bonding part 23 and the lower bonding part 24. For example, as shown in FIG. 6, the mask body 20 may be bonded by the middle bonding part 22 which is formed along a line connecting the lower bonding portion 23d of the upper bonding part 23 and the upper bonding portion 24u of the lower bonding part 24. Further, as shown in FIG. 8, the mask body 20 may be bonded by the middle bonding part 22 which is formed along a line connecting the upper bonding portion 23u of the upper bonding part 23 and the lower bonding portion 24d of the lower bonding part 24. Further, as shown in FIG. 7, by the middle bonding part 22 which is formed along the line connecting the lower bonding portion 23d of the upper bonding part 23 and the upper bonding portion 24u of the lower bonding part 24, not only the mask body 20 may be bonded together, but also the upper base 31a and the lower base 31c may be bonded to the mask body 20.

The upper bonding parts (23, 26) and the lower bonding parts (24, 27) can be formed in appropriate shapes, but preferably their end portions in the second direction 80 are formed perpendicularly (or substantially perpendicularly) to a pulling direction of the rim 35 (45). For example, the upper bonding part 23 (26) has an upper end region in the second direction 80 which extends from the upper bonding portion 23u (26u) in parallel (or substantially parallel) to the second direction 80. Further, the lower bonding part 24 (27) has a lower end region in the second direction 80 which extends from the lower bonding portion 24d (27d) in parallel (or substantially parallel) to the second direction 80.

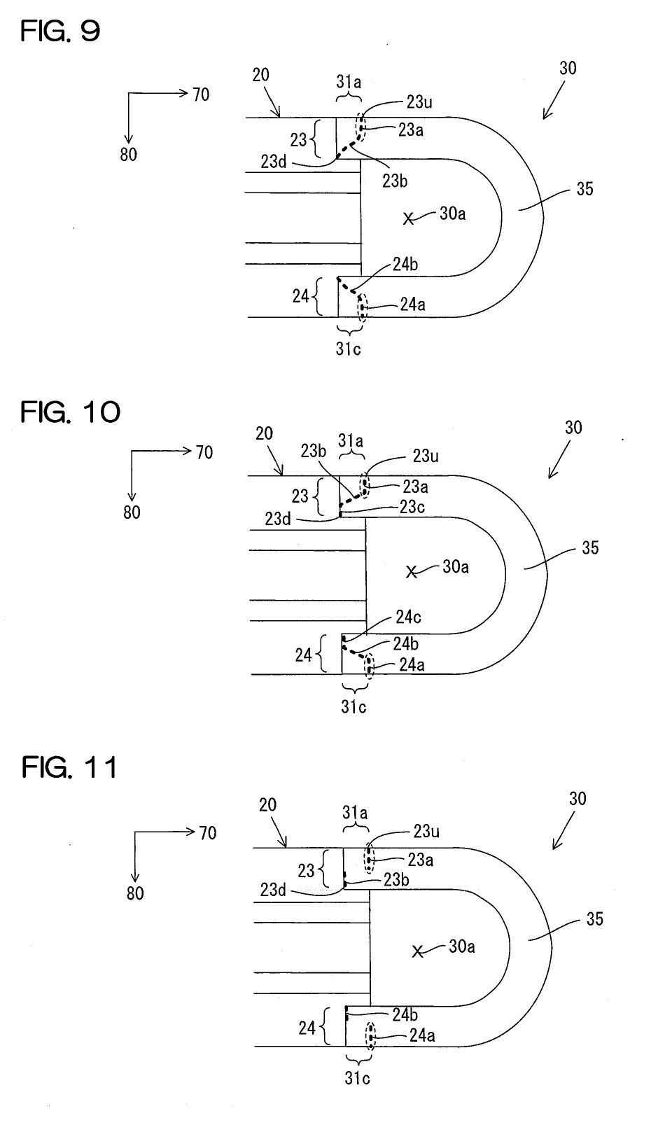

For example, the upper bonding part 23 shown in FIG. 9 has a bonding portion 23a which is formed in parallel (or substantially parallel) to the second direction 80 in a region (shown surrounded by a broken line) extending from the upper bonding portion 23u, and a bonding portion 23b formed along a curved line.

Further, the upper bonding part 23 shown in FIG. 10 has a bonding portion 23a which is formed in parallel (or substantially parallel) to the second direction 80 in a region (shown surrounded by a broken line) extending from the upper bonding portion 23u, and bonding portions 23b, 23c formed along a stepped line.

Further, the upper bonding part 23 shown in FIG. 11 has a bonding portion 23a which in formed in parallel (or substantially parallel) to the second direction 80 in a region (shown surrounded by a broken line) extending from the upper bonding portion 23u, and a bonding portion 23b formed in parallel (or substantially parallel) to the second direction 80 (the bonding portions 23a and 23b are discontinuously formed).

With this construction in which the end portions of the upper bonding part (23, 26) and the lower bonding part (24, 27) in the second direction 80 are formed perpendicularly to the pulling direction of the rim 35 (45) (the first direction 70), the upper bonding part (23, 26) and the lower bonding part (24, 27) increase in strength against tensile stress exerted in the pulling direction (the first direction 70).

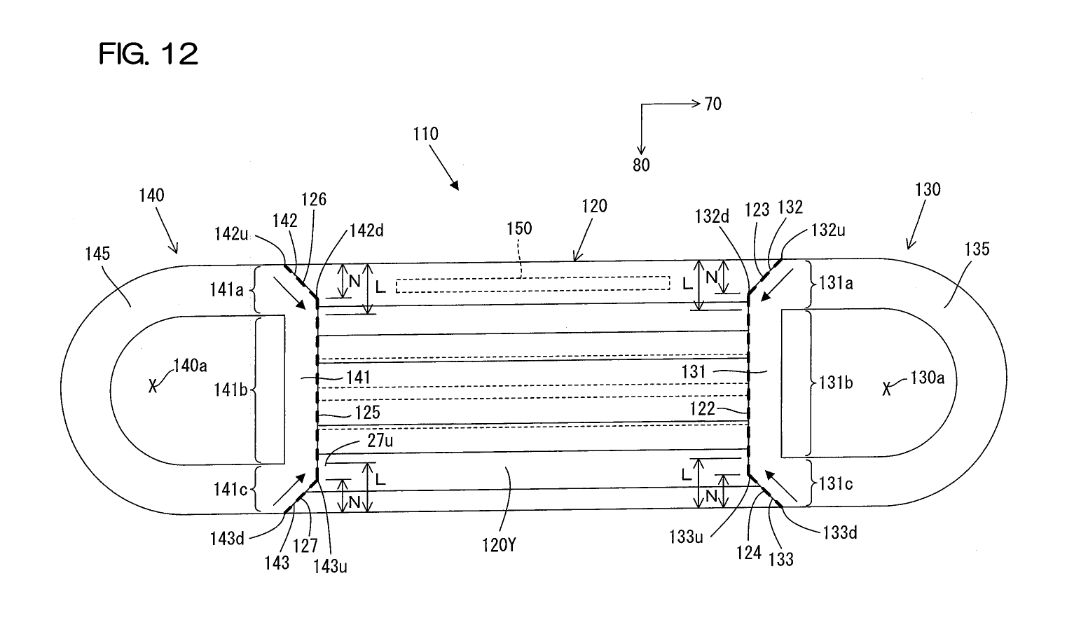

A mask 110 according to a second embodiment of the present invention is shown in FIG. 12.

A left ear strap 130 of the mask 110 according to this embodiment has a base 131. The base 131 has an upper base 131a, a middle base 131b and a lower base 131c which are disposed in order from top to bottom in the second direction 80. A rim 135 which defines an opening 130a extends from the upper base 131a and the lower base 131c. Further, the upper base 131a has an oblique portion 132 in its upper region in the second direction 80 and the lower base 131c has an oblique portion 133 in its lower region in the second direction 80. The left ear strap 130 is bonded to a mask body 120 by a left bonding part (a middle bonding part 122, an upper bonding part 123 and a lower bonding part 124) formed along the edge of the base 131. The upper bonding part 123 has a lower bonding portion assigned to a lower end 132d of the oblique portion 132 and an upper bonding portion assigned to an upper end 132u of the oblique portion 132, and the lower bonding portion is disposed to the opposite side of the upper bonding portion from the rim 135 in the first direction 70. Further, the lower bonding part 124 has an upper bonding portion assigned to an upper end 133u of the oblique portion 133 and a lower bonding portion assigned to a lower end 133d of the oblique portion 133, and the upper bonding portion is disposed to the opposite side of the lower bonding portion from the rim 135 in the first direction 70.

Similarly, the right ear strap 140 has a base 141 including an upper base 141a, a middle base 141b and a lower base 141c, and a rim 145 extending from the upper base 141a and the lower base 141c. The upper base 141a has an oblique portion 126 in its upper region in the second direction 80 and the lower base 141c has an oblique portion 127 in its lower region in the second direction 80. The right ear strap 140 is bonded to the mask body 120 by a right bonding part (a middle bonding part 125, an upper bonding part 126 and a lower bonding part 127) formed along the edge of the base 141.

Further, a vertical distance N of each of the oblique portions 132, 133, 142, 143 is preferably 30% or more of a length L of each of the upper bases 131a, 141a and the lower bases 131c, 141c in the second direction 80. With such a construction, a difference in the degree of stretching which is caused when the mask is worn can be effectively reduced. Further, the shape of the oblique portions 132, 133, 142, 143 is not limited to a straight line, but they may be formed in various other shapes.

In the above-described embodiment, each of the upper bonding parts (23, 26, 123, 126) and the lower bonding parts (24, 27, 124, 127) is formed to have the upper bonding portion and the lower bonding portion which are displaced in position with respect to each other in the first direction. Generally, the degree of stretching when the mask is worn is greater in an upper region (on a wearer's nose contact side) than in a lower region (on a wearer's mouth contact side). Therefore, only the upper bonding parts (23, 26, 123, 126) may be formed such that their upper and lower bonding portions are displaced from each other in position in the first direction.

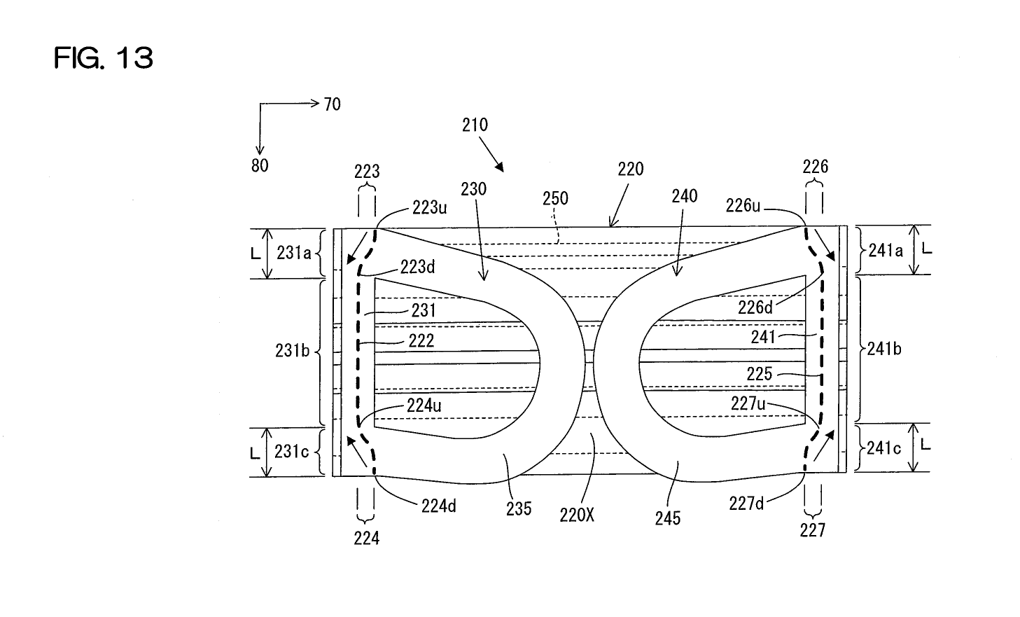

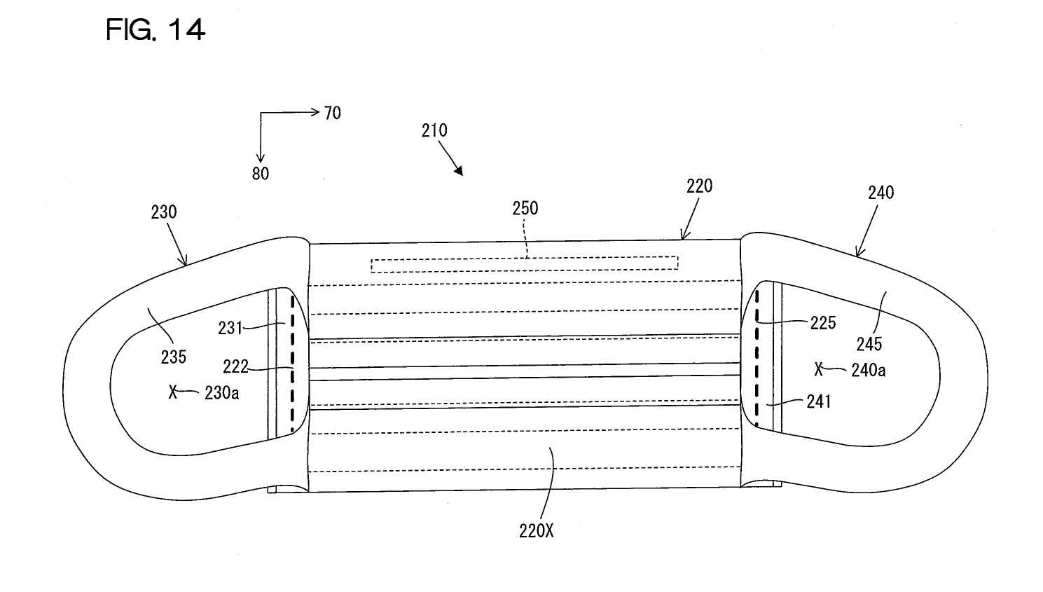

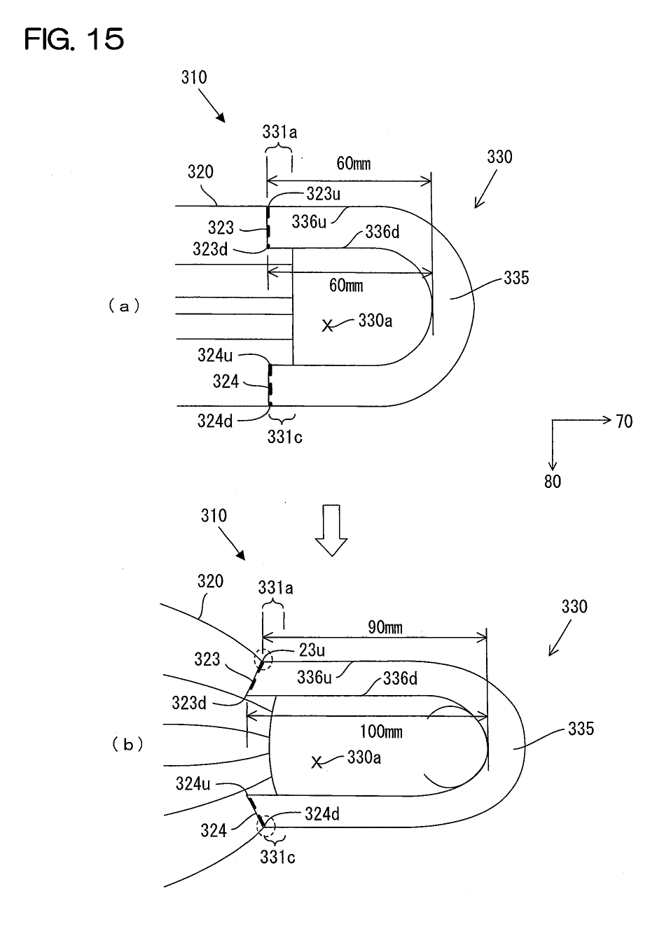

Other methods can also be used to prevent space from being formed between the mask body and the wearer's face when the mask is worn. A mask 210 of a third embodiment according to the present invention is shown in FIGS. 13 and 14. FIG. 13 shows the mask 210 of this embodiment when the mask is not worn, as viewed from a mask wearing face 220X side, and FIG. 14 shows the mask 210 of this embodiment when the mask is worn, as viewed from the mask wearing face 220X side. Further, the right and left in FIGS. 13 and 14 corresponds to the “one side in the first direction” and the “the other side in the first direction”, respectively, according to this invention.

The mask 210 according to this embodiment includes a mask body 220, a left ear strap 230 and a right ear strap 240. The mask body 220 has the same construction as the above-described mask body 20. Further, the mask body 220, the left ear strap 230 and the right ear strap 240 are formed by similar sheet pieces for the mask body 20, the left ear strap 30 and the right ear strap 40 which are described above.

The left ear strap 230 has a base 231 and a rim (ear strap part) 235 which extends from the base 231 and defines an opening 230a. The base 231 has an upper base 231a, a middle base 231b and a lower base 231c which are disposed in order from top to bottom in the second direction 80. The rim (ear strap part) 235 extends from the upper base 231a and the lower base 231c. The base 231 and the rim 235 are features that correspond to the “first base” and the “first rim”, respectively, according to this invention. Further, the upper base 231a, the middle base 231b and the lower base 231c are features that correspond to the “first upper base”, the “first middle base” and the “first lower base”, respectively, according to this invention.

The left ear strap 230 is disposed on the other (left) end region of the wearing face 220X of the mask body 220 in the first direction 70 such that the rim 235 is located on the one side (right) of the base 231 in the first direction 70.

The base 231 of the left ear strap 230 is then bonded in part to the mask body 220 by a left bonding part. In this embodiment, the base 231 is bonded to the mask body 220 by the left bonding part in the upper base 231a, the middle base 231b and the lower base 231c. Specifically, the left bonding part includes an upper bonding part 223 for bonding the upper base 231a to the mask body 220, a middle bonding part 222 for bonding the middle base 231b to the mask body 220 and a lower bonding part 224 for bonding the lower base 231c to the mask body 220. The left bonding part is formed such that a portion of the ear strap on the rim 235 side of the left bonding part can be folded back along the region of the left bonding part in the first direction 70. The left bonding part, the upper bonding part 223, the middle bonding part 222 and the lower bonding part 224 are features that correspond to the “first bonding part”, the “first upper bonding part”, the “first middle bonding part” and the “first lower bonding part”, respectively, according to this invention.

Like the left ear strap 230, the right ear strap 240 has a base 241 and a rim (ear strap part) 245 which extends from the base 241 and defines an opening 240a. The base 241 has an upper base 241a, a middle base 241b and a lower base 241c which are disposed in order from top to bottom along the second direction 80. The rim 245 extends from the upper base 241a and the lower base 241c. The base 241 and the rim 245 are features that correspond to the “second base” and the “second rim”, respectively, according to this invention. Further, the upper base 241a, the middle base 241b and the lower base 241c are features that correspond to the “second upper base”, the “second middle base” and the “second lower base”, respectively, according to this invention.

The right ear strap 240 is disposed on one (right) end region of the wearing face 220X of the mask body 220 in the first direction 70 such that the rim 245 is located on the other side (left) of the base 241 in the first direction 70.

The base 241 of the right ear strap 240 is then bonded in part to the mask body 220 by a right bonding part. In this embodiment, the base 241 is bonded to the mask body 220 by the right bonding part in the upper base 241a, the middle base 241b and the lower base 241c. Specifically, the right bonding part includes an upper bonding part 226 for bonding the upper base 241a to the mask body 220, a middle bonding part 225 for bonding the middle base 241b to the mask body 220 and a lower bonding part 227 for bonding the lower base 241c to the mask body 220. The right bonding part is formed such that a portion of the ear strap on the rim 245 side of the right bonding part can be folded back along the region of the right bonding part in the first direction 70. The right bonding part, the upper bonding part 226, the middle bonding part 225 and the lower bonding part 227 are features that correspond to the “second bonding part”, the “second upper bonding part”, the “second middle bonding part” and the “second lower bonding part”, respectively, according to this invention.

As described above, the left ear strap 230 and the right ear strap 240 are disposed on the left and right end regions of the wearing face 220X of the mask body 220 in the first direction. Further, at this time, the rims (235, 245) are located inward of the base (231, 241) (toward the center of the mask body) in the first direction 70, or specifically, such that the rim 235 of the left ear strap 230 and the rim 245 of the right ear strap 240 are opposed to each other in the first direction 70. Then the base 231 of the left ear strap 230 is bonded in part to the mask body 220 by the left bonding part, and the base 241 of the right ear strap 240 is bonded in part to the mask body 220 by the right bonding part.

When the mask is not worn, the left ear strap 230 and the right ear strap 240 are overlaid on the wearing face 220X of the mask body 220, so that the mask 210 becomes substantially as small as the mask body 220 in size (area). Therefore, when the mask is not worn (not in use), the mask is easy to pack and easy to carry.

Next, an operation of putting on the mask 210 according to this embodiment is now explained. In the state shown in FIG. 13, central regions of the pleats 20B, 20J on the both ends of the mask body 220 in the second direction 80 are pulled along the second direction 80, so that the mask body 220 is made three-dimensional.

Further, as shown in FIG. 14, the left ear strap 230 and the right ear strap 240 are folded back in the first direction 70 (the horizontal direction). Specifically, the rim 235 of the left ear strap 230 is folded back to the left (the other side) in the first direction 70. Thus, a portion of the left ear strap 230 on the rim 235 side of the left bonding part is folded back along the region of the left bonding part. Further, the rim 245 of the right ear strap 240 is folded back to the right (one side) in the first direction 70, so that a portion of the right ear strap 240 on the rim 245 side of the right bonding part is folded back along the region of the right bonding part.

Then the left ear strap 230 is hooked around the wearer's left ear through the opening 230a and the right ear strap 240 is also hooked around the wearer's right ear through the opening 240a.

At this time, part of the folded portion of the left ear strap 230 is disposed between the left bonding part and the wearer. Specifically, the left bonding part is covered by the part of the folded portion of the left ear strap 230. Further, part of the folded portion of the right ear strap 240 is disposed between the right bonding part and the wearer. Specifically, the right bonding part is covered by the part of the folded portion of the right ear strap 240.

With such a construction, space can be prevented from being formed between the mask body 220 and the wearer's face, and the left and right bonding parts can be prevented from coming in direct contact with the wearer's skin.

Further, in this embodiment, not only a portion of the upper base 231a (241a) and a portion of the lower base 231c (241c) of the left ear strap 230 (the right ear strap 240) on the rim 235 (245) side of the upper bonding part 223 (226), but a portion of the middle base 231b (241b) on the rim 235 (245) side of the middle bonding part 222 (225) is folded back. With such a construction, the strength of bonding between the left ear strap 230 (the right ear strap 240) and the mask body 220 can be increased by providing the left bonding part (the right bonding part) between the upper base 231a (241a) and the lower base 231c (241c), while the bonding part is prevented from coming in contact with the wearer's skin.

Further, in this embodiment, the middle bonding part 222 (225) in the middle base 231b (241b) extends in the second direction substantially at the same location in the first direction 70 (substantially in parallel to the second direction 80). On the other hand, the upper bonding part 223 (226) in the upper base 231a (241a) and the lower bonding part 224 (227) in the lower base 231c (241c) extend in the second direction in such a manner as to be displaced in position in the first direction 70.

The upper bonding part 223 (226) has an upper bonding portion 223u (226u) on its upper end in the second direction 80 and a lower bonding portion 223d (226d) on its lower end in the second direction 80, and the lower bonding portion 223d (226d) is disposed to the opposite side of the upper bonding portion 223u (226u) from the rim 235 (245) in the first direction 70. Further, an appropriate bonding part is formed between the upper bonding portion 223u (226u) and the lower bonding portion 223d (226d).

Further, the lower bonding part 224 (227) has an upper bonding portion 224u (227u) on its upper end in the second direction 80 and a lower bonding portion 224d (227d) on its lower end in the second direction 80, and the upper bonding portion 224u (227u) is disposed to the opposite side of the lower bonding part 224 (227) from the rim 235 (245) in the first direction 70. Further, a bonding part having an appropriate shape is formed between the upper bonding portion 224u (227u) and the lower bonding portion 224d (227d).

Further, the shape and location (in the first direction 70) of the left and right bonding parts can be appropriately selected, but preferably they are selected such that the left and right bonding parts can be covered by part of the portion folded back along the regions of the left and right bonding parts.

Thus, in this embodiment, the upper bonding part 223 of the left bonding part (the first bonding part) is gradually displaced in position to one side (to the right) in the first direction 70 from the upper bonding portion 223u on the upper end in the second direction 80 to the lower bonding portion 223d on the lower end in the second direction 80. The upper bonding part 226 of the right bonding part (the second bonding part) is gradually displaced in position to the other side (to the left) in the first direction 70 from the upper bonding portion 226u on the upper end in the second direction 80 to the lower bonding portion 226d on the lower end in the second direction 80. With such a construction, when the mask is worn, space can be effectively prevented from being formed between the mask body 220 and the wearer in the regions of the upper bases 231a and 241a.

Further, the lower bonding part 224 of the left bonding part (the first bonding part) is gradually displaced in position to the other side (to the left) in the first direction 70 from the lower bonding portion 224d on the lower end in the second direction 80 to the upper bonding portion 224u on the upper end in the second direction 80. The lower bonding part 227 of the right bonding part (the second bonding part) is gradually displaced in position to one side (to the right) in the first direction 70 from the lower bonding portion 227d on the lower end in the second direction 80 to the upper bonding portion 227u on the upper end in the second direction 80. With such a construction, when the mask is worn, space can be effectively prevented from being formed between the mask body 220 and the wearer in the regions of the lower bases 231c and 241c.

In this embodiment, it is essential that at least the upper bonding portions 223 and 226 are formed such that their upper and lower bonding portions are displaced from each other in position in the first direction 70 and the second direction 80.

The mask 210 according to this embodiment can be defined as follows:

“A mask, including a mask body which covers a wearer's mouth and first and second ear straps which are designed to be hooked around wearer's ears, the first and second ear straps being bonded to the mask body by first and second bonding parts, respectively, which are located away from each other in a first direction, wherein:

the first ear strap has a first lower base and a first upper base which are located away from each other in a second direction transverse to the first direction, and a first rim which defines an opening, wherein the first lower base is disposed to one side of the first upper base in the second direction and the first rim extends from the first lower base and the first upper base,

the second ear strap has a second lower base and a second upper base which are located away from each other in the second direction, and a second rim which defines an opening, wherein the second lower base is disposed to one side of the second upper base in the second direction and the second rim extends from the second lower base and the second upper base,

the first ear strap and the second ear strap are disposed on a wearing face of the mask body such that the first rim and the second rim are opposed in the first direction,

the first bonding part has a first upper bonding part for bonding the first upper base to the mask body and a first lower bonding part for bonding the first lower base to the mask body,

the second bonding part has a second upper bonding part for bonding the second upper base to the mask body and a second lower bonding part for bonding the second lower base to the mask body,

the first upper bonding part is provided such that an end portion of the first upper bonding part on the other side in the second direction is disposed to the one side in the first direction with respect to an end portion of the first upper bonding part on the one side in the second direction, and

the second upper bonding part is provided such that an end portion of the second upper bonding part on the other side in the second direction is disposed to the one side in the second direction with respect to an end portion of the second upper bonding part on the one side in the second direction.”

The present invention is not limited to the above-described embodiments, but rather, may be added to, changed, replaced with alternatives or otherwise modified.

The mask body, the left ear strap and the right ear strap can be formed in various configurations. For example, the mask body may be designed to take a three-dimensional shape at least when the mask is worn, or to be always held in a planar shape.

The mask body, the left ear strap and the right ear strap can be formed by using various materials and methods. Further, the mask body, the left ear strap and the right ear strap can be bonded together by using various methods.

The pleats of the mask body can be appropriately changed in shape.

The left bonding part (first bonding part) and the right bonding part (second bonding part) can be appropriately changed in shape and position. Further, the bonding part can be continuously formed, or it can be formed from differently shaped bonding portions which are discontinuously arranged.

Each of the features or structures explained in the embodiments can be used singly or in combination with other appropriately selected ones.

Further, following aspects can be provided according to the invention:

### (Aspect 1)

A mask, including a mask body which covers a wearer's mouth, and first and second ear straps which are designed to be hooked around wearer's ears, the first and second ear straps being bonded to the mask body by a first bonding part and a second bonding part, respectively, which are located away from each other in a first direction, wherein:

the mask body has a plurality of pleats which extend along the first direction,

the first ear strap has a first lower base and a first upper base which are located away from each other in a second direction transverse to the first direction, and a first rim which defines an opening, wherein the first lower base is disposed to one side of the first upper base in the second direction and the first rim extends from the first lower base and the first upper base,

the second ear strap has a second lower base and a second upper base which are located away from each other in the second direction, and a second rim which defines an opening, wherein the second lower base is disposed to one side of the second upper base in the second direction and the second rim extends from the second lower base and the second upper base,

the first ear strap and the second ear strap are disposed on a wearing face of the mask body such that the first rim and the second rim are opposed in the first direction,

the first bonding part has a first upper bonding part for bonding the first upper base to the mask body and a first lower bonding part for bonding the first lower base to the mask body,

the second bonding part has a second upper bonding part for bonding the second upper base to the mask body and a second lower bonding part for bonding the second lower base to the mask body,

the first upper bonding part is provided such that an end portion of the first upper bonding part on the one side in the second direction is disposed to the one side in the first direction with respect to an end portion of the first upper bonding part on the other side in the second direction, and

the second upper bonding part is provided such that an end portion of the second upper bonding part on the one side in the second direction is disposed to the other side in the first direction with respect to an end portion of the second upper bonding part on the other side in the second direction.

### (Aspect 2)

The mask as defined in claim 1, wherein the first lower bonding part is provided such that an end portion of the first lower bonding part on the other side in the second direction is disposed to the one side in the first direction with respect to an end portion of the first lower bonding part on the one side in the second direction, and the second lower bonding part is provided such that an end portion of the second lower bonding part on the other side in the second direction is disposed to the other side in the first direction with respect to an end portion of the second lower bonding part on the one side in the second direction.

### DESCRIPTION OF NUMERALS

10, 110, 210, 310 mask
20, 120, 220, 320 mask body
20B to 20J pleat
20X wearing face
20Y, 120Y non-wearing face
21a to 21j folding line
22, 122, 222 middle bonding part
23, 26, 123, 126, 223, 226, 323 upper bonding part
23u, 24u, 26u, 27u, 223u, 224u, 226u, 227u upper bonding portion
23d, 24d, 26d, 27d, 223d, 224d, 226d, 227d lower bonding portion
24, 27, 124, 127, 224, 227, 324 lower bonding part
25, 125, 225 middle bonding part
30, 130, 230, 330 left ear strap (first ear strap)
30a, 40a, 130a, 140a, 230a, 240a, 330a opening
31a, 41a, 131a, 141a, 231a, 241a, 331a upper base
131b, 141b, 231b, 241b middle base
31c, 41c, 131c, 141c, 231c, 241c, 331c lower base
35, 45, 135, 145, 235, 245, 335 rim
40, 140, 240 right ear strap (second ear strap)
70 first direction (horizontal direction)
80 second direction (vertical direction)
90 third direction (front-back direction)
132, 133, 142, 143 oblique portion
132u, 133u, 142u, 143u upper end
132d, 133d, 142d, 143d lower end

1. A mask comprising a mask body which covers a wearer's mouth, and first and second ear straps which are designed to be hooked around wearer's ears, the first and second ear straps being bonded to the mask body by a first bonding part and a second bonding part, respectively, which are located away from each other in a first direction, wherein:
the mask body has a plurality of pleats which extend along the first direction,
the first ear strap has a first lower base and a first upper base which are located away from each other in a second direction transverse to the first direction, and a first rim which defines an opening, wherein the first lower base is disposed to one side of the first upper base in the second direction and the first rim extends from the first lower base and the first upper base,
the second ear strap has a second lower base and a second upper base which are located away from each other in the second direction, and a second rim which defines an opening, wherein the second lower base is disposed to one side of the second upper base in the second direction and the second rim extends from the second lower base and the second upper base,
the first ear strap and the second ear strap are disposed on a wearing face of the mask body such that the first rim and the second rim are opposed in the first direction,
the first bonding part has a first upper bonding part for bonding the first upper base to the mask body and a first lower bonding part for bonding the first lower base to the mask body,
the second bonding part has a second upper bonding part for bonding the second upper base to the mask body and a second lower bonding part for bonding the second lower base to the mask body,
the first upper bonding part is provided such that an end portion of the first upper bonding part on the one side in the second direction is disposed to the one side in the first direction with respect to an end portion of the first upper bonding part on the other side in the second direction, and
the second upper bonding part is provided such that an end portion of the second upper bonding part on the one side in the second direction is disposed to the other side in the first direction with respect to an end portion of the second upper bonding part on the other side in the second direction.

2. The mask as defined in claim 1, wherein the first lower bonding part is provided such that an end portion of the first lower bonding part on the other side in the second direction is disposed to the one side in the first direction with respect to an end portion of the first lower bonding part on the one side in the second direction, and the second lower bonding part is provided such that an end portion of the second lower bonding part on the other side in the second direction is disposed to the other side in the first direction with respect to an end portion of the second lower bonding part on the one side in the second direction.
